(19) United States
(12) Patent Application Publication
(10) Pub. No.: US 2013/0256963 A1
(43) Pub. Date: Oct. 3, 2013

(54) Clean cutting board

(71) Applicants: Yedidia Shofet, Los Angeles, CA (US); Ben Naim, Los Angeles, CA (US)

(72) Inventors: Yedidia Shofet, Los Angeles, CA (US); Ben Naim, Los Angeles, CA (US)

(21) Appl. No.: 13/506,189

(22) Filed: Apr. 3, 2012

(51) Int. Cl. A47J 47/00

(52) U.S. Cl. 269/13; 269/15

(57) ABSTRACT

The “Clean Cutting Board” is a new design in kitchen cutting boards that maintains a cleaner cutting surface and cleaner surrounding area by allowing the liquid and cutting waste to flow into and be placed in the bottom holding tray to be placed directly into the trash without leaving an unsanitary mess making clean up faster and easier.

### BACKGROUND OF THE INVENTION

(1) Field of the Invention

Kitchen cutting boards have been around for hundreds of years and come in many shapes and sizes which most are flat with no drainage or storage for waste.

(2) Description of the Art Including Information Disclosed Under 37 CFR 1.97 & 1.98

The art described in the drawings of the design and function to illustrate the unique ability to drain liquids into the lower tray and put the cutting waste into the tray as well making it cleaner.

### BRIEF SUMMARY OF THE INVENTION

The “Clean Cutting Board” is a new design and utility cutting board for vegetables, fruits, and meats. The surface allows the liquid from what is being cut and drains it into the unique tray design. It has an opening at the front end that allows the larger pieces of waste to be placed into the tray easily keeping the surface much cleaner and allowing any waste to be dumped into the trash. It can be made of plastic, wood, or metal and can be several sizes as to the application needed.

### BRIEF DESCRIPTION OF THE SEVERAL VIEWS OF THE DRAWINGS

There are 12 drawings in total that describe and illustrate the design and function of the “Clean Cutting Board”.

FIG. 1: Shows the front view of the cutting board top and bottom tray.

FIG. 2: Shows the rear view of the cutting board top and bottom tray.

FIG. 3: Shows the left bottom view of the tray with the indented handle with non-slip rubber pads.

FIG. 4: Shows the right bottom view of the tray with the indented handle with non-slip rubber pads.

FIG. 5: Shows the top side view of the cutting board with the side views in view as well.

FIG. 6: Shows the bottom side view of the cutting board with the support ribs and slanted openings with the edge groove for fitting onto the bottom tray fitting firmly into place.

FIG. 7: Shows the left side view of the angled slit opening.

FIG. 8: Shows the right side view of the angled slit opening.

FIG. 9: Shows the overall view of the angled slit openings from the right side.

FIG. 10: Shows the overall view of the angled slit openings from the left side.

FIG. 11: Shows the bottom view of the cutting board top with the slanted slit opening with the edge groove that fits onto the bottom tray for a firm fit and the large opening for larger pieces of waste.

FIG. 12: Shows the top view of the cutting board top surface with the smaller slit on top and larger opening at the bottom side with the larger opening for the larger pieces of waste.

### DESCRIPTION OF THE PREFERRED EMBODIMENT

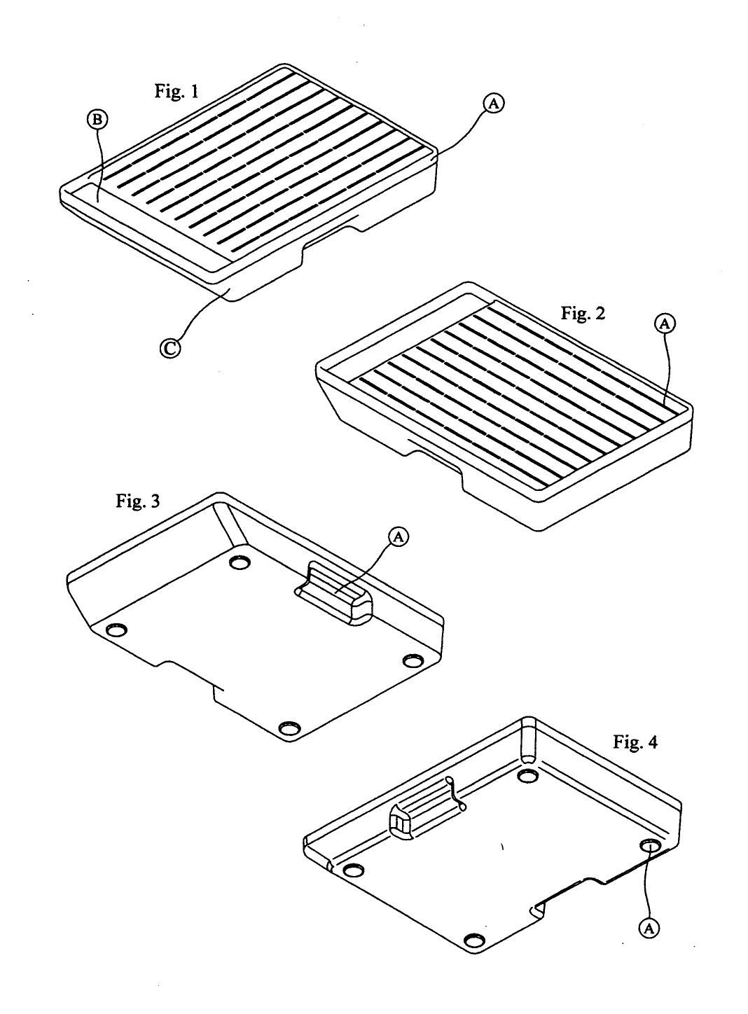

FIG. 1: Shows (A) the cutting board surface top area with (B) the larger opening for placing larger waste pieces into the (C) bottom holding tray to hold the liquid and larger waste pieces.

FIG. 2: Shows (A) the small slit opening in the cutting board surface that allows the liquid from cutting vegetables, fruits, and meats to flow into the bottom holding tray below.

FIG. 3: Shows (A) the indented handle on the side of the bottom holding tray allowing easy grasp with the hands to move the clean cutting board around the countertop surface area.

FIG. 4: Shows (A) the non-slip rubber pads that support the bottom holding tray and the entire unit giving the unit a solid contact with the countertop surface.

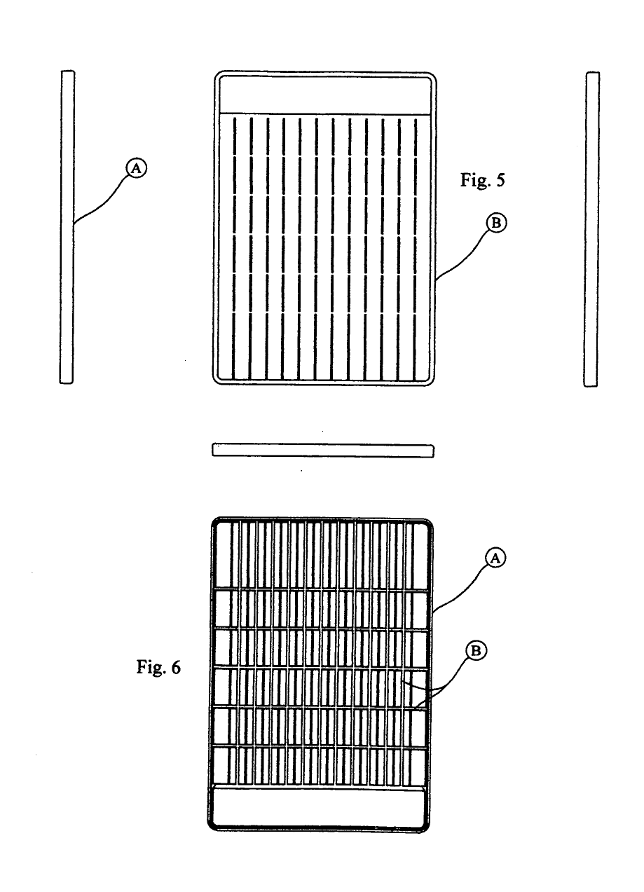

FIG. 5: Shows the top view of the cutting board surface with the small opening slits with the (A) side view of the thickness of the cutting board and with (B) the outside portion of the groove in the bottom side of the cutting board top showing the rectangular shape of the entire unit.

FIG. 6: Shows the bottom side view of the cutting board top surface area with (A) the small groove running along the entire edge of the cutting board top to secure it to the bottom holding tray with (B) the support ribs running length wise between each slit and running the width between the slits as well.

FIG. 7: Shows the (A) the angle of the bottom portion of the slit allowing liquid to flow more freely through the slit opening from the top of the cutting board surface so that the liquid does not collect in the slit. (B) This view is from the right side of the top also showing the small groove that attaches to the bottom holding tray edge for a firm grip.

FIG. 8: (A) This view is from the left of the top also showing the small groove that attaches to the bottom holding tray edge for a firm grip. (B) shows the angle of the bottom portion of the slit allowing liquid to flow more freely through the slit opening from the top of the cutting board surface so that the liquid does not collect in the slit.

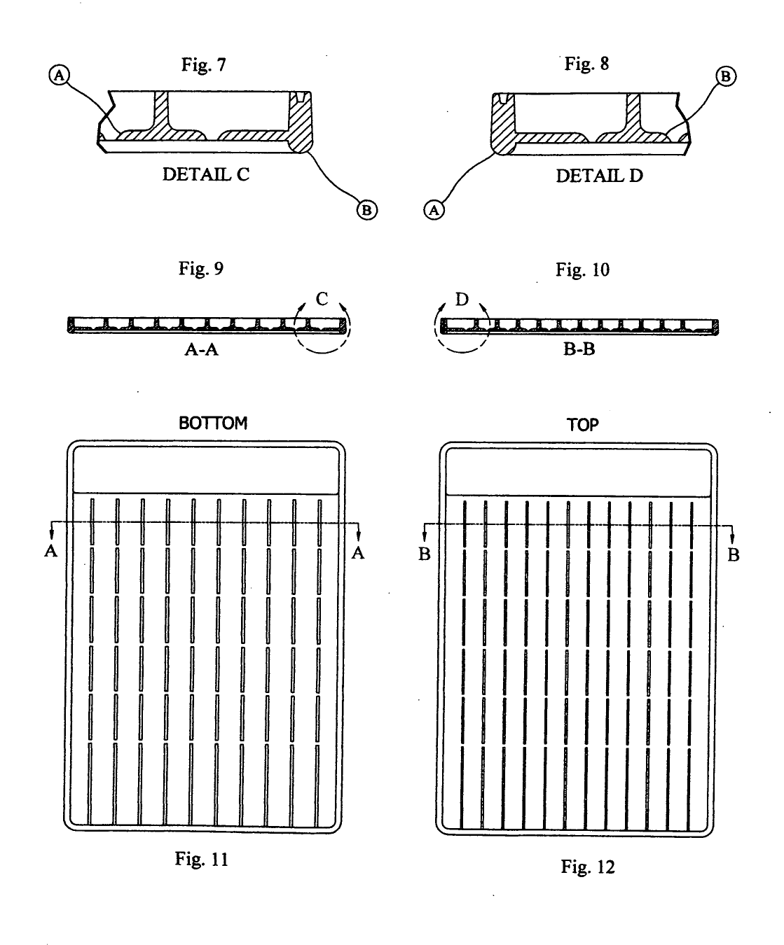

FIG. 9: (A-A) Shows the entire width of the top grid supports with the angled slit opening at the bottom from the (C) right side view.

FIG. 10: (B-B) Shows the entire width of the top grid supports with the angled slit opening at the bottom from the (D) left side view.

FIG. 11: Shows (A) the entire cutting board top from the bottom side support surface illustrating the slightly larger opening because of the slanted design allowing a better liquid flow into the bottom tray also showing the larger opening for the larger waste pieces.

FIG. 12: Shows (B) the top view of the cutting board with the smaller slits allowing the initial flow of liquid into the tray below also showing the larger opening for the larger waste pieces.

### DETAILED DESCRIPTION OF THE INVENTION

The “Clean Cutting Board” has a unique design for a more clean cutting environment. The top cutting surface has very thin slit openings that allow the liquid from vegetables, fruits, and meats to flow into the bottom tray without any cut pieces falling through the slits. It also has a larger opening at the front to allow the larger pieces of waste to be placed into the opening and into the bottom tray. This allows the cutting board surface to remain cleaner and keeps the entire area of the countertop to be free of any waste and take the waste from the bottom tray to be placed into the trash. It allows the countertop surface to be cleaned with a minimum of effort. The cutting board top and bottom tray are easily cleaned with soap and water and take up less space. It has a unique rectangular design making it easier to use and has more surface area for cutting and trimming food. It can be made of plastic, wood, or metal and can be several sizes depending on the application needed.

I claim:

1: An apparatus comprised of a rectangular shape of numerous sizes according to the application of use and made of numerous materials such as plastic, wood, and metal if needed for a particular application with a large opening at the front end of the board surface to allow larger pieces of waste to be placed into the bottom holding tray.

2: An apparatus that has a top cutting board surface with small slits molded into the board surface which are length wise in direction and elongated in shape to allow liquid from what is being cut to flow freely through the slit with an angle below the surface on the underside of the board surface to allow liquid to flow freely with no collection of the liquid to stop the flow.

3: An apparatus with support ribs running length wise and width wise on the underside of the board top surface to add strength support for the board top surface with a small groove within the outside edge of the board top to fit into the bottom holding tray top edge with a firm attachment to prevent movement.

4: An apparatus that is comprised of a holding tray in the same shape as the board top with indented handles on each side of the bottom holding tray which has an angled front end to allow the larger cut pieces to slide through the front opening into the bottom holding tray easier and will allow easier release of the larger pieces into the trash.

5: An apparatus that is comprised of all the parts described in claims 1, 2, 3, 4, which results in a more sanitary and easy and fast to clean process than an apparatus without the specific design to purpose as with this apparatus.
